(19) United States
(12) Patent Application Publication
(10) Pub. No.: US 2022/0217027 A9
(43) Pub. Date: Jul. 7, 2022

(54) WIRELESS COMMUNICATION DEVICE

(71) Applicant: NXP USA, Inc., Austin, TX (US)

(72) Inventors: Rui Cao, Sunnyvale, CA (US); Liwen Chu, San Ramon, CA (US); Young Hoon Kwon, Laguna Niguel, CA (US); Hongyuan Zhang, Fremont, CA (US); SUDHIR SRINIVASA, LOS GATOS, CA (US)

(21) Appl. No.: 17/181,935

(22) Filed: Feb. 22, 2021

Related U.S. Application Data
(60) Provisional application No. 63/033,799, filed on Jun. 2, 2020.
(60) Provisional application No. 62/980,207, filed on Feb. 22, 2020.

(51) Int. Cl. H04L 27/26; H04L 29/06; H04L 5/00

(52) U.S. Cl. CPC H04L 27/2603; H04L 27/2621; H04L 5/003; H04L 69/08

(57) ABSTRACT

One example discloses an IEEE 802.11 compliant wireless communications device, including: a processor configured to generate a hybrid-physical protocol data unit (hybrid-PPDU) that includes a set of sub-PPDUs; a first sub-PPDU in the set of sub-PPDUs includes a first preamble portion and a first data payload portion; a second sub-PPDU in the set of sub-PPDUs includes a second preamble portion and a second data payload portion; wherein an OFDMA communications signal includes a set of symbol tones divided into a set of resource units (RUs); wherein the processor is configured to map the first sub-PPDU to a first RU within the set of RUs, and map the second sub-PPDU to a second RU within the set of RUs; and wherein the first preamble portion corresponds to a first 802.11 packet format, and the second preamble portion corresponds to a second 802.11 packet format.

### REFERENCE TO PROVISIONAL APPLICATION TO CLAIM PRIORITY

A priority date for this present U.S. patent application has been established by prior U.S. Provisional Patent Application, Ser. No. 62/980,207, entitled “Hybrid-PPDU design for WiFi”, filed on 22 Feb. 2020, and prior U.S. Provisional Patent Application, Ser. No. 63/033,799, entitled “Hybrid-PPDU design followup”, filed on 2 Jun. 2020, both commonly assigned to NXP USA, Inc.

### INCORPORATION BY REFERENCE UNDER 37CFR § 1.57

The specification herein incorporates by reference U.S. Patent Application Publication 20200382998, Ser. No. 16/882,366, entitled “Extra High Throughput Preamble” published on Dec. 3, 2020.

The present specification relates to systems, methods, apparatuses, devices, articles of manufacture and instructions for wireless communications.

### SUMMARY

According to an example embodiment, an IEEE 802.11 compliant wireless communications device, comprising: a processor configured to generate a hybrid-physical protocol data unit (hybrid-PPDU) that includes a set of sub-PPDUs; a first sub-PPDU in the set of sub-PPDUs includes a first preamble portion and a first data payload portion; a second sub-PPDU in the set of sub-PPDUs includes a second preamble portion and a second data payload portion; wherein the processor is configured to either encode the sub-PPDUs into, or decode the sub-PPDUs from, an Orthogonal frequency-division multiple access (OFDMA) modulated communications signal; wherein the OFDMA communications signal includes a set of symbol tones divided into a set of resource units (RUs); wherein the processor is configured to map the first sub-PPDU to a first RU within the set of RUs, and map the second sub-PPDU to a second RU within the set of RUs; and wherein the first preamble portion corresponds to a first 802.11 packet format, and the second preamble portion corresponds to a second 802.11 packet format.

In another example embodiment, the first sub-PPDU is configured to be routed to a first station (STA) configured to communicate using the first 802.11 packet format; and the second sub-PPDU is configured to be routed to a second station (STA) configured to communicate using the second 802.11 packet format.

In another example embodiment, the first 802.11 packet format is different from the second 802.11 packet format.

In another example embodiment, the wireless communications device is configured to be networked with additional wireless communications devices into a BSS (Basic Service Set); and each of the additional wireless communications devices is configured to communicate with different packet formats.

In another example embodiment, each of the RUs correspond to a different frequency band within the OFDMA communications signal; and at least two of the different frequency bands have different bandwidths.

In another example embodiment, each of the sub-PPDUs are self-contained.

In another example embodiment, the set of sub-PPDUs have packet formats corresponding to any combination of: an HE packet format; an EHT packet format; and an EHT+ packet format.

In another example embodiment, the processor is configured to send an announcement frame prior to transmission of the OFDMA communications signal; and the announcement frame assigns resources and a control channel to a receiving station (STA).

In another example embodiment, each of the sub-PPDUs have a same total duration to maintain an orthogonality of the OFDMA communications signal.

In another example embodiment, if the first preamble has a shorter duration than the second preamble, then the processor is configured to pad the first preamble to maintain an orthogonality of the OFDMA communications signal.

In another example embodiment, if the first preamble maps to fewer symbol tones than the second preamble, then the processor is configured to pad the first preamble to maintain an orthogonality of the OFDMA communications signal; and the pad is a set of dummy user information.

In another example embodiment, if the first data payload maps to fewer symbol tones than the second data payload, then the processor is configured to pad the first data payload to maintain an orthogonality of the OFDMA communications signal; and the pad is a set of dummy data.

In another example embodiment, if the first data preamble maps to fewer symbol tones than the second data preamble, then the processor is configured to select a different Modulation and Coding Scheme (MCS) to maintain an orthogonality of the OFDMA communications signal.

In another example embodiment, the first sub-PPDU includes a first tone spacing, the second sub-PPDU includes a second tone spacing, and the first and second tone spacings are different such that the OFDMA communications signal is not orthogonal.

In another example embodiment, the first sub-PPDU uses either a non-HT, HT or VHT PPDU packet format, and the second sub-PPDU uses either an HE, EHT or future PPDU packet format.

In another example embodiment, a low pass filter is applied to each sub-PPDU before constructing the hybrid-PPDU.

In another example embodiment, a phase change is added to the first and second preamble portions, and/or to the first and second data payload portions.

In another example embodiment, a ramping phase change is added to the first and second preamble portions, and/or to the first and second data payload portions.

In another example embodiment, a first phase rotation modulates the first preamble and/or data payload portions; and a second phase rotation modulates the second preamble and/or data payload portions.

In another example embodiment, the processor is configured to add an indication that a total bandwidth of the hybrid-PPDU is greater than a total PPDU bandwidth indicated in at least one of the sub-PPDUs.

In another example embodiment, the processor is configured to detect a peak-to-average power ratio (PAPR) in that would exceed a predetermined threshold PAPR at least one of the preamble portions; and the processor is configured to optimize the preamble PAPR for each signal bandwidth and sub-PPDU packet format using a per-20 MHz phase rotation and/or a +1/−1 sequence design.

According to an example embodiment, a method for enabling an IEEE 802.11 compliant wireless communications device to be operated, comprising: distributing a set of instructions, stored on a non-transitory, tangible computer readable storage medium, for configuring the wireless communications device; wherein the instructions include: generating a hybrid-physical protocol data unit (hybrid-PPDU) that includes a set of sub-PPDUs; generating a first sub-PPDU in the set of sub-PPDUs includes a first preamble portion and a first data payload portion; generating a second sub-PPDU in the set of sub-PPDUs includes a second preamble portion and a second data payload portion; encoding the sub-PPDUs into, and/or decoding the sub-PPDUs from, an Orthogonal frequency-division multiple access (OFDMA) modulated communications signal; wherein the OFDMA communications signal includes a set of symbol tones divided into a set of resource units (RUs); mapping the first sub-PPDU to a first RU within the set of RUs, and mapping the second sub-PPDU to a second RU within the set of RUs; and wherein the first preamble portion corresponds to a first 802.11 packet format, and the second preamble portion corresponds to a second 802.11 packet format.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents an example wireless communications network (WLAN) formed by a set of wireless communications devices (i.e. APs and STAs).

FIG. 2 represents an example set of PPDU data structures.

FIG. 3 represents a first example hybrid-PPDU data structure.

FIG. 4A represents a second example hybrid-PPDU data structure.

FIG. 4B represents a third example hybrid-PPDU data structure.

FIG. 4C represents a fourth example hybrid-PPDU data structure.

FIG. 4D represents a fifth example hybrid-PPDU data structure.

FIG. 4E represents a sixth example hybrid-PPDU data structure.

FIG. 4F represents a seventh example hybrid-PPDU data structure.

FIG. 4G represents an eighth example hybrid-PPDU data structure.

FIG. 4H represents a ninth example hybrid-PPDU data structure.

FIG. 5 represents an example set of instructions for enabling a hybrid-PPDU data structure within a wireless communications device.

FIG. 6 represents an example system for hosting instructions for enabling the hybrid-PPDU data structure within the wireless communications device.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

IEEE (Institute of Electrical and Electronics Engineers) 802 defines communications standards for various networked devices (e.g. Local Area Networks (LAN), Metropolitan Area Networks (MAN), etc.). IEEE 802.11 further defines communications standards for Wireless Local Area Networks (WLAN). As such, communications on these networks must, by agreement, follow one or more communications protocols so that various network devices can communicate. These protocols are not static and are modified (e.g. different generations) over time, typically to improve communications robustness and increase throughput.

In embodiments of a wireless communication network described below, a wireless communications device such as an access point (AP) of a wireless local area network (WLAN) transmits data streams to one or more client stations (STAs). The AP and STAs communicate using one or more communication protocols. These protocols may include IEEE protocols such as: 802.11b; 802.11g; 802.11a; 802.11n [i.e. HT (High Throughput) with Single-User Multiple-Input Multiple-Output (SU-MIMO)]; 802.11ac [i.e. VHT (Very High Throughput) with downlink Multi-User MIMO (MU-MIMO)]; 802.11ax [i.e. HE (High Efficiency) operating at both 2.4- and 5-GHz bands, including OFDMA (Orthogonal Frequency Division Multiple Access) and MU-MIMO with uplink scheduling]; and 802.11be [i.e. EHT (Extra High Throughput) operating at 2.4 GHz, 5 GHz, and 6 GHz frequency bands and a much wider 320 MHz bandwidth].

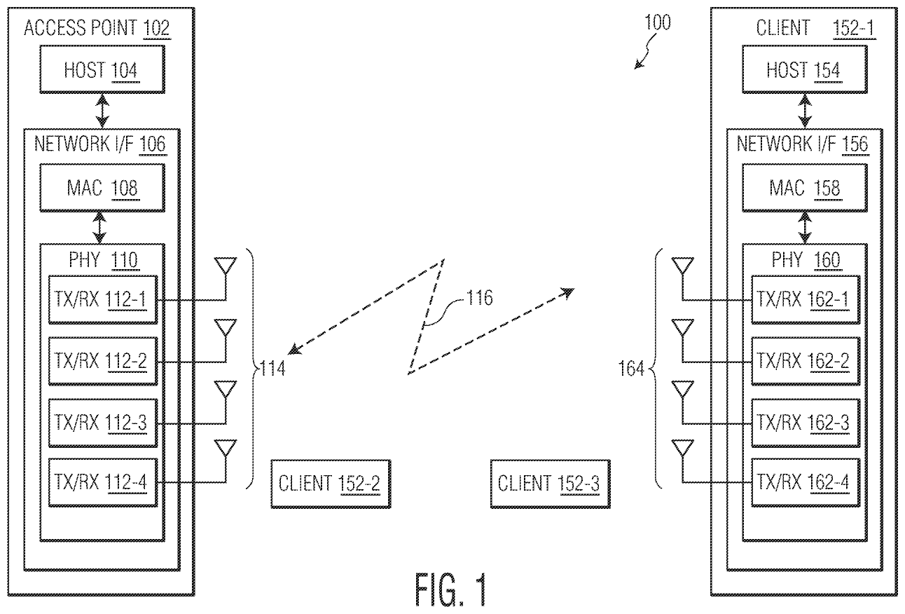

FIG. 1 represents an example 100 wireless communications network (WLAN) formed by a set of wireless communications devices (i.e. APs and STAs). The WLAN 100 includes access point (AP) 102 and a set of client stations (STAs) 152-1, 152-2, and 152-3.

The AP 102 includes host processor 104 coupled to network interface 106. Host processor 104 includes a processor configured to execute machine readable instructions stored in a memory device (not shown), e.g., random access memory (RAM), read-only memory (ROM), a flash memory, or other storage device.

Network interface 106 includes medium access control (MAC) processor 108 and physical layer (PHY) processor 110. In some example embodiments the MAC processor 108 operates at the data-link layer of the OSI (Open Systems Interconnection) model and the PHY processor 110 operates at the physical layer of the OSI model.

The PHY processor 110 includes a plurality of transceivers 112-1, 112-2, 112-3, and 112-4, each of which is coupled to a corresponding antenna of antennas 114. These antennas 114 can support MIMO functionality. Each of transceivers 112-1, 112-2, 112-3, and 112-4 includes a transmitter signal path and a receiver signal path, e.g., mixed-signal circuits, analog circuits, and digital signal processing circuits for implementing radio frequency and digital baseband functionality. The PHY processor 110 may also include an amplifier (e.g., low noise amplifier or power amplifier), a data converter, and circuits that perform discrete Fourier transform (DFT), inverse discrete Fourier transform (IDFT), modulation, and demodulation, thereby supporting OFDMA modulation.

The client STAs 152-1, 152-2, and 152-3 each include similar circuits (e.g., host processor 154, network interface 156, MAC processor 158, PHY processor 160, transceivers 162-1, 162-2, 162-3, and 162-4, and antennas 164) that provide similar functionality to that of AP 102 but are adapted to client-side specifications.

The MAC 108, 158 and PHY 110, 160 processors within the AP 102 and STA 152-1 exchange PDUs (Protocol Data Units) and SDUs (Service Data Units) in the course of managing the wireless communications traffic. The PHY processor is configured to receive MAC layer SDUs, encapsulate the MAC SDUs into a special PDU called a PPDU (Physical Layer Convergence Procedure (PLCP) PDU) by adding a preamble.

The preamble (i.e. TXVECTOR, transmission vector) specifies the PPDU's transmission format (i.e. which IEEE protocol (e.g. EHT, HE, etc.) has been used to pack the SDU data payload). The PPDU preambles may include various training fields (e.g. predetermined attributes) that are used by the receiving APs or STAs to perform synchronization, gain control, estimate channel characteristics, and signal equalization. The AP 102 and STA 152-1 then exchange the PPDU formatted wireless communications signals 116.

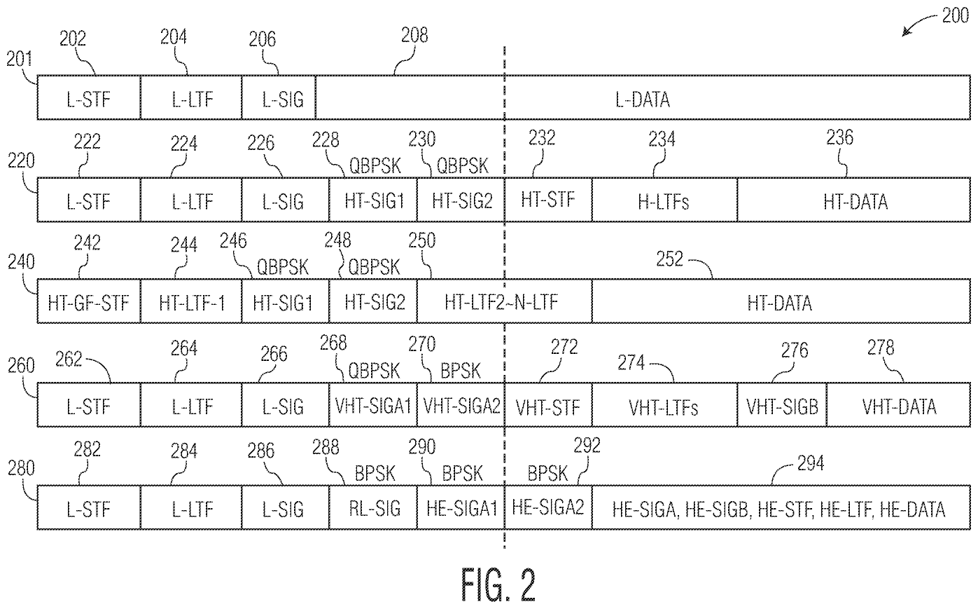

FIG. 2 represents an example 200 set of PPDU data structures 201, 220, 240, 260, 280. For example, PPDU 201 conforms to the IEEE 802.11a standard and occupies a 20 Mega-Hertz (MHz) frequency band. PPDU 201 includes a preamble having legacy short training field (L-STF) 202, generally used for packet detection, initial synchronization, and automatic gain control, etc., and legacy long training field (L-LTF) 204, generally used for channel estimation and fine synchronization. PPDU 201 also includes legacy signal field (L-SIG) 206, used to communicate certain PHY parameters of PPDU 201, e.g., modulation type and coding rate used to transmit the data unit. PPDU 201 also includes data portion 208. In at least one embodiment, PPDU 201 includes data portion 208 that is not low density parity check encoded, and includes a service field, a scrambled physical layer service data unit (PSDU), tail bits, and padding bits, if needed. PPDU 201 is designed for transmission over one spatial or space-time stream in a single-input single-output (SISO) channel configuration.

PPDU 220 conforms to the IEEE 802.11n standard, occupies a 20 MHz frequency band, and is designed for mixed mode situations, i.e., when the WLAN includes one or more client stations that conform to the IEEE 802.11a standard but not the IEEE 802.11n standard. PPDU 220 includes a preamble having L-STF 222, L-LTF 224, L-SIG 226, high throughput signal fields HT-SIG1 228 and HT-SIG2 230, high throughput short training field (HT-STF) 232, and M high throughput long training fields (HT-LTFs) 224, where M is an integer generally determined based on the number of spatial streams used to transmit data unit 220 in a multiple-input multiple-output (MIMO) configuration. In particular, according to the IEEE 802.11n standard, PPDU 220 includes two HT-LTFs 234 if the data unit is transmitted using two spatial streams, and four HT-LTFs 234 if the data unit is transmitted using three or four spatial streams. An HT-SIG field indicates the number of spatial streams being utilized. PPDU 220 also includes a data portion, HT-DATA 336.

PPDU 240 conforms to the IEEE 802.11n standard, occupies a 20 MHz frequency band, and is designed for “Greenfield” situations, i.e., when the WLAN does not include any client stations that conform to the IEEE 802.11a standard and only includes client stations that conform to the IEEE 802.11n standard. PPDU 240 includes a preamble having high throughput Greenfield short training field (HT-GF-STF) 242, first high throughput long training field (HT-LTF1) 244, HT-SIGs (e.g., HT-SIG1 246 and HT-SIG2 248), and M HT-LTFs 250, where M is an integer which generally corresponds to a number of spatial streams used to transmit a data unit in a MIMO channel configuration. PPDU 240 also includes data portion, HT-DATA 252.

PPDU 260 conforms to the IEEE 802.11ac standard and is designed for “mixed field” situations. PPDU 260 occupies a 20 MHz bandwidth. In other embodiments or scenarios, a PPDU similar to PPDU 260 occupies a different bandwidth, such as a 40 MHz, an 80 MHz, or a 160 MHz bandwidth. PPDU 260 includes a preamble having L-STF 262, L-LTF 264, L-SIG 266, two first very high throughput signal fields (VHT-SIGAs) including first very high throughput signal field (VHT-SIGA1) 268 and second very high throughput signal field (VHT-SIGA2) 270, very high throughput short training field (VHT-STF) 272, M very high throughput long training fields (VHT-LTFs) 274, where M is an integer, and second very high throughput signal field (VHT-SIG-B) 276. Data unit 260 also includes a data portion, VHT-DATA 278.

PPDU 280 conforms to the IEEE 802.11ax standard. PPDU 280 occupies a 20 MHz bandwidth. In other embodiments or scenarios, a data unit similar to a data unit having PPDU 280 occupies a different bandwidth, such as a 40 MHz, an 80 MHz, or a 160 MHz bandwidth. PPDU 280 includes a preamble having L-STF 282, L-LTF 284, L-SIG 286, RL-SIG 288, two first very high efficiency signal fields (HE-SIGA1 290 and HE-SIGA2 292) and data portion 294.

Each subsequent generation of PPDU is designed to be backward compatible with earlier generations (i.e. legacy) PPDUs. For example, legacy data unit formats 201, 220, 240, 260, and 280 implicitly signal their PPDU version by their L-SIG and L-SIG LENGTH fields.

In the above protocols, each PPDU exchanged between APs and STAs must conform to a single PPDU-type (e.g. PPDUs 201, 220, 240, 260, 280 for example) due to preamble format differences and tone spacing differences for example. However, in WiFI, the life cycle of each generation product is long and a mixture of STAs from different 802.11 generations in one BSS (Basic Service Set) is common. Several of these different generation STAs may need to transmit or receive traffic during a same time window.

Now discussed is an IEEE 802.11 compliant wireless communications device and method that enables multiple PPDU-types to be combined into a single hybrid-PPDU. This hybrid-PPDU benefits from a much greater 320 MHz channel bandwidth in 802.11be and thus provides greater wireless communications throughput and reduced latency.

Grouping STAs from different 802.11 generations in one PPDU transmission can reduce latency and increase system throughput. Starting from 11ax, 4× tone spacing is used. OFDMA transmission is also defined. It opens the door for hybrid STA grouping, grouping STAs from different generations (i.e. having different packet formats). Thus STAs of different generation can assigned to different frequency bands/segments, and each frequency band/segment can send MU (Multi-User) PPDUs using OFDMA signals to all users corresponding to the same generation.

However, as maximum supported signal BW increases to 320 MHz in EHT, the STAs that can support up to 320 MHz will be limited. Many STAs may be 20 MHz only, 80 MHz only or 160 MHz only. With a mixture of associated STAs with small BW from different generations, a smart wide-band AP (e.g. 320 MHz) will schedule STAs from different generations on different frequency band (e.g. 80 MHz). For example, HE 20 MHz only STA, 80 MHz only STA can participate in 320 MHz (160+160)/240 MHz (160+80) BSS for more efficient transmission. HE, EHT and future 20 MHz only STA, 80 MHz only, 160-only STA can be mixed together in large BW transmission. Both SU or MU PPDU formats in each sub-PPDU can be used. For UL ACK synchronization, MAC needs to set corresponding ACK solicitation mode in the PPDU or add BAR trigger in the frame.

Using the hybrid-PPDU topology, a total throughput of BSS will be higher, and latency will be lower. The hybrid-PPDU can be used for both DL and UL-TB transmissions.

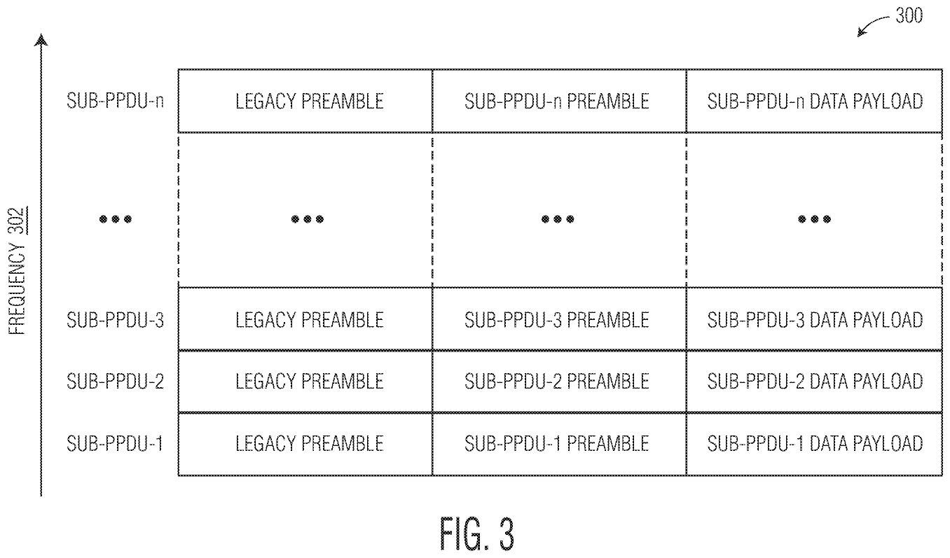

FIG. 3 represents a first example hybrid-PPDU data structure 300. The hybrid-PPDU 300 is used to transfer data packets between various access points (APs) and stations (STAs) in an IEEE 802.11 compliant wireless communications device. A processor (e.g. 104, 154) is configured to generate the hybrid-physical protocol data unit (hybrid-PPDU) 300 that includes a set of sub-PPDUs (e.g. sub-PPDUs-1, sub-PPDUs-2, sub-PPDUs-3, sub-PPDUs-n).

A first sub-PPDU (e.g. sub-PPDUs-1) in the set of sub-PPDUs includes a first preamble portion (e.g. Legacy Preamble and Sub-PPDU-1 Preamble) and a first data payload portion (e.g. Sub-PPDU-1 Data Payload). A second sub-PPDU (e.g. sub-PPDUs-2) in the set of sub-PPDUs includes a second preamble portion (e.g. Legacy Preamble and Sub-PPDU-2 Preamble) and a second data payload portion (e.g. Sub-PPDU-2 Data Payload).

The transmitting processor is configured to encode the sub-PPDUs into, and the receiving processor is configured to decode the sub-PPDUs from, an Orthogonal frequency-division multiple access (OFDMA) modulated communications signal. The OFDMA communications signal includes a set of symbol tones divided into a set of resource units (RUs). The processor is configured to map the first sub-PPDU to a first RU within the set of RUs, and map the second sub-PPDU to a second RU within the set of RUs. The first preamble portion corresponds to a first 802.11 packet format, and the second preamble portion corresponds to a second 802.11 packet format. Examples of how to build the hybrid-PPDU using different packet formats (e.g. non-HT/HT/VHT, HE, EHT, EHT+) are further discussed below.

The first sub-PPDU is configured to be routed to a first station (STA) configured to communicate using the first 802.11 packet format; and the second sub-PPDU is configured to be routed to a second station (STA) configured to communicate using the second 802.11 packet format.

In some example embodiments the first 802.11 packet format is different from the second 802.11 packet format, or more generally, each sub-PPDU in the set of sub-PPDUs may have any mixture of 802.11 packet data formats. In some example embodiments, all the sub-PPDUs may have a same packet format, and in other example embodiments all different packet formats depending upon the networked devices in the BSS (Basic Service Set).

Each of the RUs corresponds to a different frequency band within the OFDMA communications signal. Depending upon the example embodiment, the RUs may or may not have different bandwidths. Each of the sub-PPDUs are self-contained. In some example embodiments the processor is configured to send an announcement frame prior to transmission of the OFDMA communications signal that assigns resources and a control channel to a receiving station (STA).

In one example operational embodiment of the hybrid-PPDU 300, there is no primary channel switch after a STA association (i.e. setup). Instead all STAs parked on secondary channels will be allocated to the corresponding secondary frequency band. All STAs parked on primary channel will be allocated to the primary frequency band. The hybrid-PPDU 300 bandwidth field will indicate the bandwidth information of each sub-PPDU.

In another example operational embodiment of the hybrid-PPDU 300, after “association” if a STA wants to “switch” then the MAC processor 108 (data-link layer) may define a new announcement frame to announce the STA's allocation to frequency band and corresponding primary channel for each frequency band. STAs currently park on wide-band primary channel can switch to different frequency sub-band, and listen to the corresponding control channel. This gives more flexibility in terms of resource allocation for all different traffic pattern. For EHT and EHT+ U-SIG is persistent.

Regarding sub-PPDU bandwidths, in some example embodiments a preamble of each sub-PPDU in the hybrid-PPDU 300 signals it own PPDU bandwidth. This is a simple design, having more efficiency and a simpler receiver processing. However, in other example embodiments, a frequency band containing the primary channel is assigned to the STA supporting newer generation. The entire bandwidth of the hybrid-PPDU 300 is signaled in the U-SIG field. This may help with CCA for OBSS. EHT-SIG needs to signal dummy user for other “RU” spectrum that is assigned to other STAs. For the frequency band transmitting HE PPDU, it can signal the widest BW the STA supports. If the actual assigned HE PPDU uses smaller signal bandwidth, dummy user needs to be added to occupy the entire BW.

An orthogonality of the OFDMA communications signal can vary depending upon the sub-PPDU packet formats. Orthogonality is defined within the 802.11 standard, but based on the teachings in this specification further includes wherein each sub-PPDU is frequency orthogonal symbol-by-symbol and has a same tone spacing for each symbol.

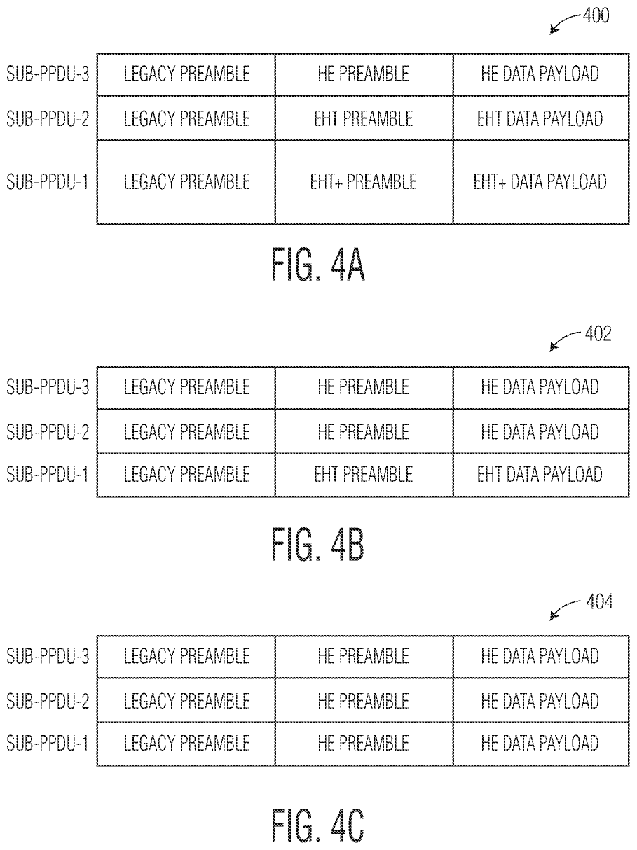

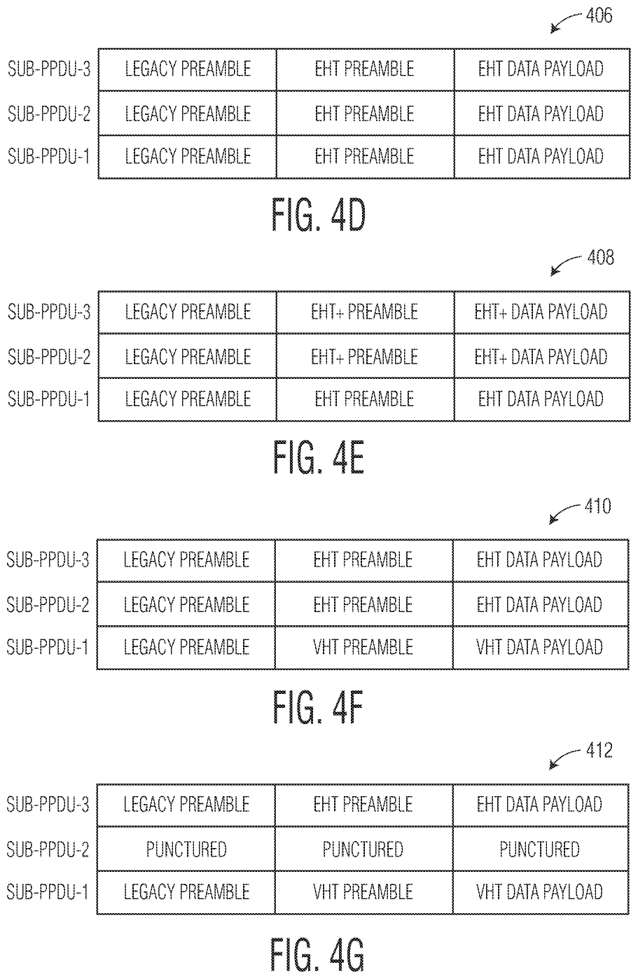

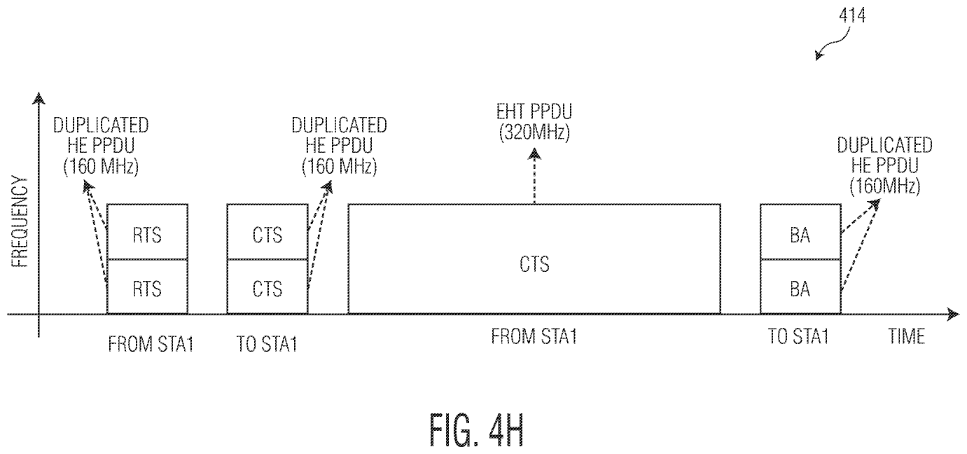

Now discussed in FIGS. 4A-4E are those packet formats where orthogonality can be maintained. Later in FIGS. 4F-4H some techniques for managing packet formats where orthogonality cannot be maintained are discussed.

In some example embodiments, each sub-PPDU can be aligned and/or padded so that they are orthogonal to each other sub-PPDU. Both the preamble and data portion are to be aligned and/or padded using one or more of the following techniques: setting a same duration for each sub-PPDU; using padding to make sure the hybrid-PPDU 300 ends at a same time; padding all sub-PPDUs so as to be equal in length to a longest sub-PPDU length.

Example applications of the above techniques for maintaining orthogonality are now presented in FIGS. 4A-4E.

FIG. 4A represents a second example hybrid-PPDU 400 data structure. The second example 400 hybrid-PPDU data structure includes: a sub-PPDU-1 EHT+ data structure, a sub-PPDU-2 EHT data structure, and a sub-PPDU-3 HE data structure.

In this example embodiment, the hybrid-PPDU conforms to 802.11.be and has a 320 MHz total bandwidth. A first and second 80 MHz segment bandwidths (160 MHz total) transmit the MU sub-PPDU-1 (EHT+). A third 80 MHz segment sub-PPDU-2 transmits an EHT MU PPDU, and a fourth 80 MHz segment sub-PPDU-3 transmits an HE MU PPDU. This mode is useful when both HE, EHT and EHT+ STAB are popular in the market. HE preamble and EHT preamble have similar structure. Pre-append legacy preambles: LSTF+LLTF+LSIG+RLSIG. The length field in LSIG/RL-SIG will be different as LENGTH % 3˜=0 in HE, and LENGTH % 3==0 in EHT and beyond. EHT USIG has a same structure as HE-SIGA with 2 symbols.

FIG. 4B represents a third example hybrid-PPDU 402 data structure. The third example hybrid-PPDU 402 includes: a sub-PPDU-1 EHT data structure, a sub-PPDU-2 HE data structure, and a sub-PPDU-3 HE data structure.

In this example embodiment, this mode allows mixed EHT and HE PPDUs. This is useful at the beginning stage of EHT deployment when most STAs are still HE STAs. HE preamble and EHT preamble have similar structure. Pre-append legacy preambles: LSTF+LLTF+LSIG+RLSIG. The length field in LSIG/RL-SIG will be different as LENGTH % 3˜=0 in HE, and LENGTH % 3==0 in EHT. EHT USIG has the same structure as HE-SIGA with 2 symbols.

In this example embodiment, OFDM orthogonality is maintained by configuring the processor to perform one or more of the following alignments: EHT-SIG vs HE-SIGB: need the same number of symbols, which can be achieved by padding dummy users to the HE-SIGB or EHT-SIG; or, choose a different Modulation and Coding Scheme (MCS) for EHT-SIG/HE-SIGB. EHT-LTF vs HE-LTF: need the same LTF format and number of LTF (number of streams). This can be achieved by assigning extra streams to dummy users. Since symbol/tone spacing are the same for EHT-Data and HE-Data, just need to pad data to guarantee the same number of data symbols

FIG. 4C represents a fourth example hybrid-PPDU 404 data structure. The fourth example hybrid-PPDU 404 includes: a sub-PPDU-1 HE data structure, a sub-PPDU-2 HE data structure, and a sub-PPDU-3 HE data structure.

In this example embodiment, only HE PPDUs are used for each sub-PPDU. This mode is useful for BSS with many HE 20 MHz or 80 MHz only STAs, the hybrid mode can save preamble overhead, and allows 320 MHz full usage for HE STAs. In one operational mode, each sub-PPDU transmits HE SU PPDU, whereas in another operational mode, each sub-PPDU transmits HE MU PPDU.

While the HE preamble structure is the same and legacy preamble is the same, in this example embodiment, OFDM orthogonality is maintained by aligning the HE-preamble symbols. In one example embodiment, the number of STS assigned to each sub-PPDU needs to guarantee that the same number of HE-LTFs between sub-PPDUs. In another example embodiment, the number of SIGB symbols and HE-LTFs need to be aligned, this can be achieved by adding dummy users for sub-PPDUs that has smaller number of SIGB symbols or HE-LTFs. HE-Data will be padded to have the same sub-PPDU length.

FIG. 4D represents a fifth example hybrid-PPDU 406 data structure. The fifth example hybrid-PPDU 406 includes: a sub-PPDU-1 EHT data structure, a sub-PPDU-2 EHT data structure, and a sub-PPDU-3 EHT data structure.

In this example embodiment, only EHT PPDUs are used for each sub-PPDU. This mode is useful for BSS with many EHT 20 MHz-only/80 MHz-only/160 MHz-only STAs, the hybrid mode can save preamble overhead, and allows 320 MHz full usage for EHT STAs. Only up to 160 MHz resource allocation signaling is needed. Reuse existing 802.11ax.

While the EHT preamble structure is the same, in this example embodiment, OFDM orthogonality is maintained by aligning the number of EHT-SIG symbols and EHT-LTFs. This can be achieved by adding dummy users for sub-PPDUs that has smaller number of EHT-SIG symbols or EHT-LTFs. EHT-Data will be padded to have the same sub-PPDU length.

FIG. 4E represents a sixth example hybrid-PPDU 408 data structure. The sixth example hybrid-PPDU 408 includes: a sub-PPDU-1 EHT data structure, a sub-PPDU-2 EHT+ data structure, and a sub-PPDU-3 EHT+ data structure.

In this example embodiment, there are mixed EHT and EHT+ PPDUs. Similar to the EHT, EHT mode, the preamble has the same structure, as USIG will be persistent for multiple future generations, EHT and beyond PPDU will share the same preamble structure. Different PHY version bits in U-SIG for each sub-PPDU. Some PHY signaling bits can be defined in U-SIG to signal hybrid-PPDU 300 and/or different hybrid-PPDU 300 combination so that wide-band receivers can detect the narrow signal.

In this example embodiment, OFDM orthogonality is maintained by, the following alignments: EHT-SIG vs EHT+SIG: need the same number of symbols. This can be achieved by padding dummy users to the EHT-SIG or EHT+SIG. EHT-LTF vs EHT+LTF: need the same number of LTF (number of streams). This can be achieved by assigning extra streams to dummy users. Pad the data-payload to guarantee a same number of data symbols for both the EHT and EHT+ data-payloads.

Even though orthogonality can be guaranteed through symbol alignment in both preamble and data portion, a high peak-to-average power ratio (PAPR) may still be observed for some sub-PPDU combinations and signal bandwidth. The preamble PAPR is optimized for each signal bandwidth and PPDU format through per-20 MHz phase rotation and +1/−1 sequence design. For hybrid-PPDU, the transmit signal bandwidth is wider than each sub-PPDU, so the preamble PAPR of the hybrid-PPDU can be larger than each sub-PPDU. A-PPDU transmitter can applied PAPR reduction techniques to enable higher transmission power or reduce signal distortion.

Now discussed in FIGS. 4F-4H are some techniques for managing packet formats where orthogonality cannot be maintained. In the example embodiments to follow, the sub-PPDUs packet format types are sufficiently different that a resulting OFDMA signal would likely not be orthogonal.

For example, while symbol boundaries for HE, EHT, and EHT+ PPDU packet formats can be aligned and/or padded, combining HE, EHT, or EHT+ with other PPDU packet formats such as non-HT/HT/VHT will result in a non-orthogonal OFDMA signal. Such non-orthogonal OFDMA signals can result in inter-carrier interference across sub-PPDUs due to signal discontinuity across symbols and GI, and intermodulation distortion because the independent phases of the various PPDU types will often combine constructively. Intermodulation distortion can raise the noise floor, may cause inter-carrier interference, and/or generate out-of-band spurious radiation. The non-orthogonal OFDMA signals can also cause a high PAPR.

Example hybrid-PPDUs that are likely to result in such non-orthogonality are shown in FIGS. 4F-4H.

FIG. 4F represents a seventh example hybrid-PPDU 410 data structure. The seventh example hybrid-PPDU 410 includes: a sub-PPDU-1 VHT data structure, a sub-PPDU-2 EHT data structure, and a sub-PPDU-3 EHT data structure. This hybrid-PPDU 410 will result in a non-orthogonal OFDMA signal due to mixing the VHT data structure with the EHT data structures.

FIG. 4G represents an eighth example hybrid-PPDU 412 data structure. The eighth example hybrid-PPDU 412 includes: a sub-PPDU-1 VHT data structure, a sub-PPDU-2 punctured data structure, and a sub-PPDU-3 EHT data structure. This eighth example 412 hybrid-PPDU data structure will also result in a non-orthogonal OFDMA signal due to mixing the VHT data structure with the EHT data structures. In FIG. 4G, what would have been a sub-PPDU-2 EHT data structure, such as shown in FIG. 4F, has in this example embodiment been punctured due to symbol interference from the VHT data structure.

Examples of managing such non-orthogonality, such as those presented in FIGS. 4F-4G, and PAPR reduction for orthogonal A-PPDU in FIGS. 4A-4E are now discussed.

PAPR, symbol interference, and intermodulation distortion caused by non-orthogonal PPDUs within the hybrid-PPDU can be reduced using one or more of the following techniques: adding high-resolution digital-to-analog converter (DAC) in the wireless communications signal chain (e.g. transceivers 112-1, 112-2, 112-3, and 112-4 and/or transceivers 162-1, 162-2, 162-3, and 162-4); adding sharper transceiver filters to each sub-PPDU, thereby reducing leakage between the sub-PPUD frequency bands; reducing non-linearity within the signal chain; adding phase rotation to the sub-PPDUs; adding phase change to the sub-PPDUs; for punctured hybrid-PPDUs, the punctured sub-PPDU can be ignored and the other sub-PPDUs processed by their respective receiving devices; and/or using subchannel selective transmission (SST) on primary channels (at least for HT/VHT, HT/VHT sub-PPDUs).

In some example embodiments, a preamble phase rotation sequence for total-bandwidth is defined. For example, hybrid-PPDU of total BW=320 MHz, then EHT 320 MHz preamble phase rotation sequence is applied to the sub-PPDU.

In some example embodiments, HT/VHT/HE sub-PPDU can use a same preamble phase rotation sequence that is defined for the sub-PPDU type.

EHT and EHT+ sub-PPDUs can also use preamble phase rotation sequence for total-bandwidth defined for newer generations. For example, an 160 MHz HE+160 MHz EHT hybrid-PPDU, the HE sub-PPDU can use the phase rotation for a 160 MHz HE PPDU. EHT 320 MHz preamble phase rotation sequence is applied to the EHT sub-PPDU, depending on where EHT sub-PPDU is located.

HT/VHT/HE sub-PPDUs can use a same preamble phase rotation sequence defined for the sub-PPDU type, while EHT and EHT+ sub-PPDUs can use a new preamble phase rotation sequence for depending on the total-bandwidth and location of the sub-PPDUs.

In some example embodiments, since a preamble in each sub-PPDU corresponds to a sub-PPDU BW, and a 20 MHz modulated preamble is used for: L-Preamble, RL-SIG, RE-SIGA/U-SIG, HE-SIGB/EHT-SIG, etc, then a per-20 MHz phase rotation can be applied to each of the sub-PPDUs. For sub-PPDU having a same BW, repeated phase rotations can be used. Note that the STF and LTF bit sequences can be the same for HE and EHT with BW<=160 MHz.

For HT/VHT/HE/EHT/EHT+ STF/LTF portion, phase change can also be used for all sub-PPDUs. If beamforming is applied in each sub-PPDU, phase will likely be discontinuous, and PAPR is not significant. However, if beamforming is not applied, then some phase rotation or phase ramping can be applied. In some example embodiments, a single phase rotation per segment or per sub-PPDU can be applied. For example, +1/−1 polarity or exp(li*θ). In other example embodiments, a ramping phase per segment or per sub-PPDU can be applied. This could be similar to cyclic shift diversity (CSD) applied per stream or per antenna. For example, for each segment or sub-PPDU, apply one CSD value. If any phase change is applied across segment or sub-PPDU, the phase change would also have to be applied on both LTF and Data portion so that the phase change would be transparent to a receiving device (i.e. a sub-PPDU receiver).

FIG. 4H represents a ninth example hybrid-PPDU 414 data structure. This example addresses a hybrid-PPDU 414 that includes both EHT and HE sub-PPDUs. Since the maximum bandwidth of an HE PPDU is limited to 160 MHz, when an EHT STA's transmission bandwidth is greater than 160 MHz, the EHT STA cannot use the HE PPDU. However, when an EHT STA transmits a PPDU that initiates a TXOP, it must still use a PPDU format that is backward compatible to HE STAs.

Thus to create the hybrid-PPDU 414 multiple duplicate HE PPDUs are added as shown in FIG. 4H. The duplicated HE sub-PPDUs in the hybrid-PPDU 414 indicate that a transmission bandwidth of the hybrid-PPDU 414 is greater than the bandwidth indicated in the HE sub-PPDU. This indication can be made for example, using a reserved bit in HE-SIG field, a TA field of a RTS frame may be set to a bandwidth signaling TA, and/or a SERVICE field may be used to indicate the actual bandwidth of the hybrid-PPDU 414.

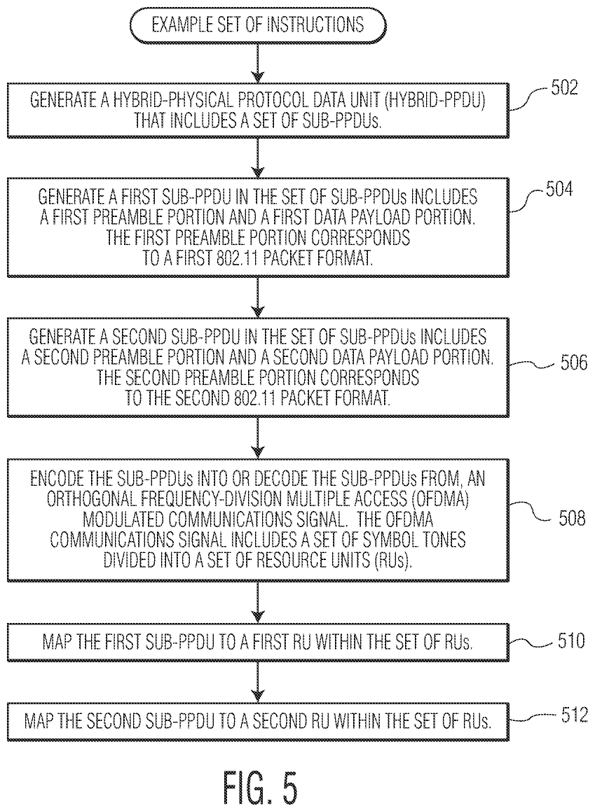

FIG. 5 represents an example 500 set of instructions for enabling a hybrid-PPDU data structure within a wireless communications device. The order in which the instructions are discussed does not limit the order in which other example embodiments implement the instructions unless otherwise specifically stated. Additionally, in some embodiments the instructions are implemented concurrently.

The example 500 instructions begin at 502 by generating a hybrid-physical protocol data unit (hybrid-PPDU) that includes a set of sub-PPDUs. In 504 generate a first sub-PPDU in the set of sub-PPDUs includes a first preamble portion and a first data payload portion. The first preamble portion corresponds to a first 802.11 packet format. In 506 generate a second sub-PPDU in the set of sub-PPDUs includes a second preamble portion and a second data payload portion. The second preamble portion corresponds to a second 802.11 packet format. In 508 encode the sub-PPDUs into, or decode the sub-PPDUs from, an Orthogonal frequency-division multiple access (OFDMA) modulated communications signal. The OFDMA communications signal includes a set of symbol tones divided into a set of resource units (RUs). In 510 map the first sub-PPDU to a first RU within the set of RUs. In 512 map the second sub-PPDU to a second RU within the set of RUs.

In some example embodiments the set of instructions described above are implemented as functional and software instructions. In other embodiments, the instructions can be implemented either using logic gates, application specific chips, firmware, as well as other hardware forms.

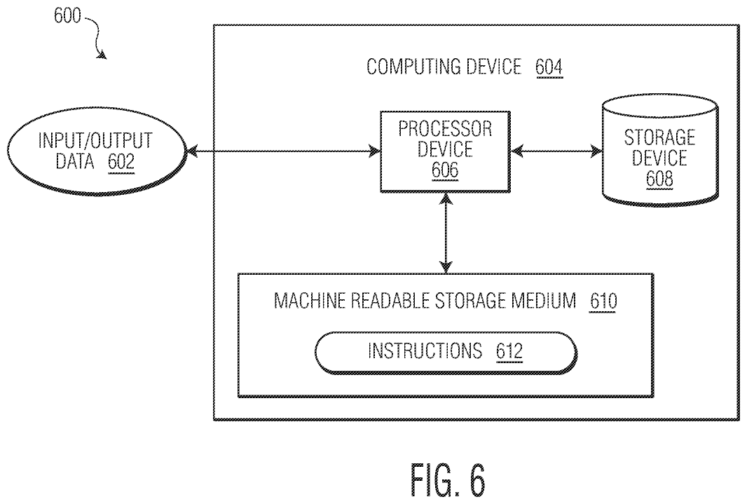

FIG. 6 represents an example 600 system for hosting instructions for enabling the hybrid-PPDU data structure within the wireless communications device. The system 600 shows an input/output data 602 interface with an electronic apparatus 604. The electronic apparatus 604 includes a processor 606, a storage device 608, and a non-transitory machine-readable storage medium 610. The machine-readable storage medium 610 includes instructions 612 which control how the processor 606 receives input data 602 and transforms the input data into output data 602, using data within the storage device 608. Example instructions 612 stored in the machine-readable storage medium 610 are discussed elsewhere in this specification. The machine-readable storage medium in an alternate example embodiment is a non-transitory computer-readable storage medium.

The processor (such as a central processing unit, CPU, microprocessor, application-specific integrated circuit (ASIC), etc.) controls the overall operation of the storage device (such as random access memory (RAM) for temporary data storage, read only memory (ROM) for permanent data storage, firmware, flash memory, external and internal hard-disk drives, and the like). The processor device communicates with the storage device and non-transitory machine-readable storage medium using a bus and performs operations and tasks that implement one or more instructions stored in the machine-readable storage medium. The machine-readable storage medium in an alternate example embodiment is a computer-readable storage medium.

Example embodiments of the material discussed in this specification can be implemented in whole or in part through network, computer, or data based devices and/or services. These may include cloud, internet, intranet, mobile, desktop, processor, look-up table, microcontroller, consumer equipment, infrastructure, or other enabling devices and services. As may be used herein and in the claims, the following non-exclusive definitions are provided.

In this specification, example embodiments have been presented in terms of a selected set of details. However, a person of ordinary skill in the art would understand that many other example embodiments may be practiced which include a different selected set of these details. It is intended that the following claims cover all possible example embodiments.

What is claimed is:

1. An IEEE 802.11 compliant wireless communications device, comprising:
a processor configured to generate a hybrid-physical protocol data unit (hybrid-PPDU) that includes a set of sub-PPDUs;
a first sub-PPDU in the set of sub-PPDUs includes a first preamble portion and a first data payload portion;
a second sub-PPDU in the set of sub-PPDUs includes a second preamble portion and a second data payload portion;
wherein the processor is configured to either encode the sub-PPDUs into, or decode the sub-PPDUs from, an Orthogonal frequency-division multiple access (OFDMA) modulated communications signal;
wherein the OFDMA communications signal includes a set of symbol tones divided into a set of resource units (RUs);
wherein the processor is configured to map the first sub-PPDU to a first RU within the set of RUs, and map the second sub-PPDU to a second RU within the set of RUs; and
wherein the first preamble portion corresponds to a first 802.11 packet format, and the second preamble portion corresponds to a second 802.11 packet format.

2. The device of claim 1:
wherein the first sub-PPDU is configured to be routed to a first station (STA) configured to communicate using the first 802.11 packet format; and
wherein the second sub-PPDU is configured to be routed to a second station (STA) configured to communicate using the second 802.11 packet format.

3. The device of claim 1:
wherein the first 802.11 packet format is different from the second 802.11 packet format.

4. The device of claim 1:
wherein the wireless communications device is configured to be networked with additional wireless communications devices into a BSS (Basic Service Set); and
wherein each of the additional wireless communications devices is configured to communicate with different packet formats.

5. The device of claim 1:
wherein each of the RUs correspond to a different frequency band within the OFDMA communications signal; and
wherein at least two of the different frequency bands have different bandwidths.

6. The device of claim 1:
wherein each of the sub-PPDUs are self-contained.

7. The device of claim 1:
wherein the set of sub-PPDUs have packet formats corresponding to any combination of: an HE packet format; an EHT packet format; and an EHT+ packet format.

8. The device of claim 1:
wherein the processor is configured to send an announcement frame prior to transmission of the OFDMA communications signal; and
wherein the announcement frame assigns resources and a control channel to a receiving station (STA).

9. The device of claim 1:
wherein each of the sub-PPDUs have a same total duration to maintain an orthogonality of the OFDMA communications signal.

10. The device of claim 1:
wherein if the first preamble has a shorter duration than the second preamble, then the processor is configured to pad the first preamble to maintain an orthogonality of the OFDMA communications signal.

11. The device of claim 1:
wherein if the first preamble maps to fewer symbol tones than the second preamble, then the processor is configured to pad the first preamble to maintain an orthogonality of the OFDMA communications signal; and
wherein the pad is a set of dummy user information.

12. The device of claim 1:
wherein if the first data payload maps to fewer symbol tones than the second data payload, then the processor is configured to pad the first data payload to maintain an orthogonality of the OFDMA communications signal; and
wherein the pad is a set of dummy data.

13. The device of claim 1:
wherein if the first data preamble maps to fewer symbol tones than the second data preamble, then the processor is configured to select a different Modulation and Coding Scheme (MCS) to maintain an orthogonality of the OFDMA communications signal.

14. The device of claim 1:
wherein the first sub-PPDU includes a first tone spacing, the second sub-PPDU includes a second tone spacing, and the first and second tone spacings are different such that the OFDMA communications signal is not orthogonal.

15. The device of claim 1:
wherein the first sub-PPDU uses either a non-HT, HT or VHT PPDU packet format, and the second sub-PPDU uses either an HE, EHT or future PPDU packet format.

16. The device of claim 1:
wherein a low pass filter is applied to each sub-PPDU before constructing the hybrid-PPDU.

17. The device of claim 1:
wherein a phase change is added to the first and second preamble portions, and/or to the first and second data payload portions.

18. The device of claim 1:
wherein a ramping phase change is added to the first and second preamble portions, and/or to the first and second data payload portions.

19. The device of claim 1:
wherein a first phase rotation modulates the first preamble and/or data payload portions; and
wherein a second phase rotation modulates the second preamble and/or data payload portions.

20. The device of claim 1:
wherein the processor is configured to add an indication that a total bandwidth of the hybrid-PPDU is greater than a total PPDU bandwidth indicated in at least one of the sub-PPDUs.

21. The device of claim 1:
wherein the processor is configured to detect a peak-to-average power ratio (PAPR) in that would exceed a predetermined threshold PAPR at least one of the preamble portions; and
wherein the processor is configured to optimize the preamble PAPR for each signal bandwidth and sub-PPDU packet format using a per-20 MHz phase rotation and/or a +1/−1 sequence design.

22. Method for enabling an IEEE 802.11 compliant wireless communications device to be operated, comprising:
distributing a set of instructions, stored on a non-transitory, tangible computer readable storage medium, for configuring the wireless communications device;
wherein the instructions include:
generating a hybrid-physical protocol data unit (hybrid-PPDU) that includes a set of sub-PPDUs;
generating a first sub-PPDU in the set of sub-PPDUs includes a first preamble portion and a first data payload portion;
generating a second sub-PPDU in the set of sub-PPDUs includes a second preamble portion and a second data payload portion;
encoding the sub-PPDUs into, and/or decoding the sub-PPDUs from, an Orthogonal frequency-division multiple access (OFDMA) modulated communications signal;
wherein the OFDMA communications signal includes a set of symbol tones divided into a set of resource units (RUs);
mapping the first sub-PPDU to a first RU within the set of RUs, and mapping the second sub-PPDU to a second RU within the set of RUs; and
wherein the first preamble portion corresponds to a first 802.11 packet format, and the second preamble portion corresponds to a second 802.11 packet format.
